(19) United States
(12) Patent Application Publication
(10) Pub. No.: US 2025/0322196 A1
(43) Pub. Date: Oct. 16, 2025

(54) IMAGE FORMING APPARATUS, CONTROL METHOD FOR THE SAME, AND STORAGE MEDIUM

(71) Applicant: CANON KABUSHIKI KAISHA, Tokyo (JP)

(72) Inventor: NAOKI MORITA, Chiba (JP)

(21) Appl. No.: 19/171,751

(22) Filed: Apr. 7, 2025

(30) Foreign Application Priority Data
Apr. 10, 2024 (JP) 2024-063309

(51) Int. Cl. G06K 15/02; H04N 1/00

(52) U.S. Cl. CPC G06K 15/1868; G06K 15/1886; H04N 1/0044

(57) ABSTRACT

An image forming apparatus includes a reception unit configured to receive first image data, an acquisition unit configured to acquire second image data corresponding to a boundary of an item by scanning the item, a changing unit configured to resize an image based on the first image data to fit within the boundary of the item on an image based on the second image data without receiving a size specification for the image based on the first image data from a user, and a printing unit configured to print the image resized by the changing unit on a printing medium.

### BACKGROUND

### Field of the Disclosure

The present disclosure relates to an image forming apparatus and a control method therefor.

### Description of the Related Art

There is a use case in which a user makes original goods by printing desired images, cutting the printed images to fit the size of an item, and bonding the cut images to the item.

Japanese Patent Application Laid-Open No. 11-242578 discusses a method in which scanned image data obtained by a printing apparatus is incorporated into image data included in a print job received by the printing apparatus to generate image data, and an image is printed based on the generated image data.

In the method discussed in Japanese Patent Application Laid-Open No. 11-242578, the user can specify a region of a desired size at a desired location in a first image. The printing apparatus can resize a second image to fit in the region of the first image specified by the user and combine the resized second image into the region.

Examples of original goods made by the user include fans, badges, and keychains, and there may be a case where the size of an item differs from the size of an image to be printed. Thus, the method discussed in Japanese Patent Application Laid-Open No. 11-242578 involves the user changing print settings as appropriate so that the image is printed to fit the item, which can be bothersome.

### SUMMARY

According to embodiments of the present disclosure, an image forming apparatus includes a reception unit configured to receive first image data, an acquisition unit configured to acquire second image data corresponding to a boundary of an item by scanning the item, a changing unit configured to resize an image based on the first image data to fit within the boundary of the item on an image based on the second image data without receiving a size specification for the image based on the first image data from a user, and a printing unit configured to print the image resized by the changing unit on a printing medium.

Further features of the present disclosure will become apparent from the following description of exemplary embodiments with reference to the attached drawings.

### BRIEF DESCRIPTION OF THE DRAWINGS

FIG. 1 is a diagram illustrating an example of a network configuration of an image processing system.

FIG. 2 is a diagram illustrating an example of a hardware configuration of an information processing apparatus.

FIG. 3 is a diagram illustrating an example of a hardware configuration of an image processing apparatus.

FIG. 4 is a diagram illustrating an example of a software configuration of the information processing apparatus.

FIG. 5 is a diagram illustrating an example of a software configuration of the image processing apparatus.

FIGS. 6A and 6B are diagrams illustrating examples of print setting dialogs.

FIG. 7 is a flowchart illustrating an example of a printing process.

FIGS. 8A and 8B are diagrams illustrating examples of a home screen of the image processing apparatus and a scaling print application screen.

FIGS. 9A to 9C are diagrams illustrating examples of image data, an item, and a boundary image of the item.

FIGS. 10A to 10C are diagrams illustrating examples of screens displayed during an image adjustment process.

FIGS. 11A to 11C are diagrams illustrating examples of screens that display an automatic adjustment result.

FIG. 12 is a flowchart illustrating an example of a process after a print job is received by the image processing apparatus.

FIG. 13 is a flowchart illustrating an example of the image adjustment process.

FIGS. 14A and 14B are diagrams illustrating examples of an additional scanning confirmation screen and an item scanning range.

### DESCRIPTION OF THE EMBODIMENTS

Some embodiments of the present disclosure will now be described in detail with reference to the drawings. The embodiments are not intended to limit the disclosure and not all combinations of features described in the embodiments are used for the technical solution of the disclosure.

A first exemplary embodiment of the present disclosure will be described.

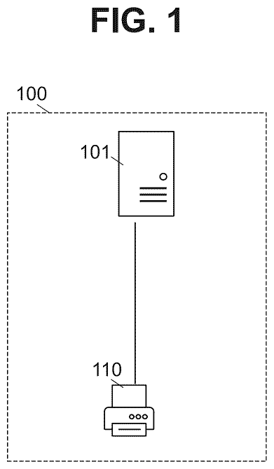

FIG. 1 is a diagram illustrating an example of a network configuration of an image processing system 100 according to the present exemplary embodiment.

The image processing system 100 includes an information processing apparatus 101 and an image processing apparatus 110. The information processing apparatus 101 and the image processing apparatus 110 are connected to a network and can communicate with each other. The image processing apparatus 110 is also an image forming apparatus.

The information processing apparatus 101 generates image data, generates print jobs including the image data, and transmits the print jobs to the image processing system 100. The information processing apparatus 101 is, for example, a smartphone.

The image processing apparatus 110 receives the print jobs from the information processing apparatus 101 and performs printing. Further, the image processing apparatus 110 displays various types of information to a user, receives inputs from the user, and performs processes described below. The image processing apparatus 110 is, for example, a multi-function peripheral (MFP).

While the information processing apparatus 101 and the image processing apparatus 110 exchange data via the network in the present exemplary embodiment, this is not a limitation. Any method can be used as long as the information processing apparatus 101 and the image processing apparatus 110 can exchange data, including a method using a storage device, such as a Universal Serial Bus (USB) memory, a method using a public switched telephone network, such as a fax, and a method using the Internet, such as cloud printing.

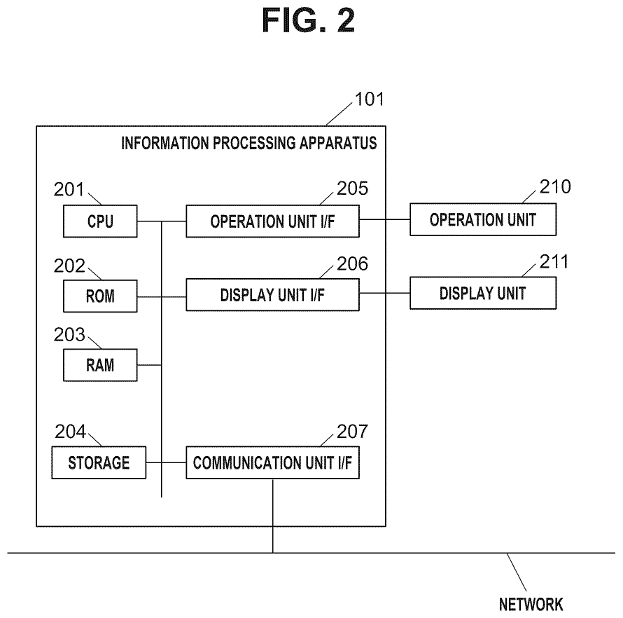

FIG. 2 is a diagram illustrating an example of a hardware configuration of the information processing apparatus 101.

The information processing apparatus 101 includes a central processing unit (CPU) 201, a read-only memory (ROM) 202, a random-access memory (RAM) 203, a storage 204, an operation unit interface (operation unit I/F) 205, a display unit interface (display unit I/F) 206, a communication unit interface (communication unit I/F) 207, an operation unit 210, and a display unit 211.

The CPU 201 controls the pieces of hardware 202 to 207 included in the information processing apparatus 101 to carry out functions of the information processing apparatus 101. The CPU 201 transmits signals to the pieces of hardware via a bus line and performs data communication with other hardware. Further, the CPU 201 of the information processing apparatus 101 controls the operation of the information processing apparatus 101 based on control programs stored in the ROM 202. More specifically, the CPU 201 runs an operating system (OS) configured to control the information processing apparatus 101. Then, application programs installed on the OS interact with each other to perform and control the functions desired by the user. The OS and various programs are stored in the ROM 202 and loaded into the RAM 203 to be executed.

The ROM 202 is a memory for storing programs and various types of data used by the CPU 201. The RAM 203 is a working memory for temporarily storing programs used by the CPU 201 and data used in computation. The storage 204 is a storage device that stores various types of data and programs. While the storage 204 is intended to be a hard disk in the present exemplary embodiment, another non-volatile storage device, such as a solid-state drive (SSD), can be used.

The operation unit I/F 205 is used for connecting the CPU 201 to the operation unit 210, such as a keyboard, a mouse, a touch panel, or a button. The display unit I/F 206 is used for connecting the CPU 201 to the display unit 211, such as a liquid crystal monitor or a touch panel. The communication unit I/F 207 is a network I/F for performing wired local area network (wired LAN) communication, such as Ethernet. The operation unit 210 is, for example, a button, a keyboard, a mouse, a directional pad, or a trackpad, and receives user inputs.

The display unit 211 is, for example, a display or a touch panel, and displays various types of information. If a touch panel is used as the display unit 211, the user can input information with the touch panel, so that the display unit 211 and the operation unit 210 can be configured as the same unit.

The communication unit I/F 207 may be a network I/F for performing wireless local area network (wireless LAN) communication or a USB I/F. The wireless LAN communication refers to, for example, Wi-Fi®. Further, the communication unit I/F 207 can be configured to perform communications using Bluetooth®.

While FIG. 2 illustrates the information processing apparatus 101 connected to the external operation unit 210 and the external display unit 211, the operation unit 210 and the display unit 211 can be built in or integrated into the information processing apparatus 101.

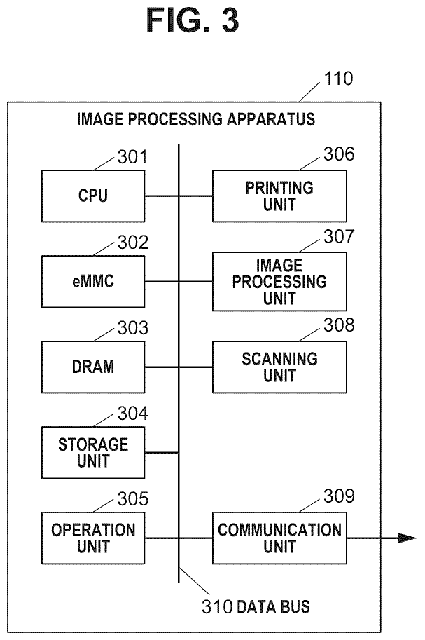

FIG. 3 is a diagram illustrating an example of a hardware configuration of the image processing apparatus 110. A CPU 301 is a system control unit and controls the image processing apparatus 110. An embedded Multimedia Card (eMMC) 302 includes flash memory and configured to store control programs for the CPU 301.

In the present exemplary embodiment, application programs that run on the image processing apparatus 110 are stored in the eMMC 302.

A dynamic RAM (DRAM) 303 is a volatile memory for storing program control variables and can temporarily store image data and print jobs processed by the CPU 301. In the present exemplary embodiment, applications that run on the image processing apparatus 110 are read from the eMMC 302, loaded into the DRAM 303, and executed by the CPU 301. Further, temporary values used in various processes are stored in the DRAM 303. A storage unit 304 is a storage device, such as a hard disk drive (HDD) device, and is a non-volatile memory that stores data, such as text and images. In the present exemplary embodiment, various types of data, such as a print job, are stored in the storage unit 304.

An operation unit 305 is an interface unit between the image processing apparatus 110 and the user, which displays information and receives user inputs. The operation unit 305 includes, for example, a display, a button, a keyboard, a mouse, a touch panel, a directional pad, and a trackpad, and the display and the touch panel also display various types of information. The operation unit 305 is an example of an instruction reception unit configured to receive user instructions.

A printing unit 306 prints images on recording paper based on image data. In the present exemplary embodiment, the printing unit 306 performs printing by applying and fixing toner to the recording paper with pressure using a heated fixing device. This is not a limiting printing method for the printing unit 306, and the printing unit 306 can also employ an inkjet printing method in which printing is performed by applying ink.

An image processing unit 307 edits, combines, and renders image data. In the present exemplary embodiment, the image processing unit 307 performs processes related to operations on image data, such as image scaling and edge (reference) detection. A scanning unit 308 scans document (item) images and converts the scanned images into scalable image data, such as in Joint Photographic Experts Group (JPEG) or binary format. Further, the CPU 301 causes the image processing unit 307 to perform encryption and image processing based on settings at the time of a scanning on the image data obtained by the scanning unit 308. The scanning unit 308 stores state information about the scanning unit 308, including a status of the scanning operation and error information, in the DRAM 303 and notifies the state information to the CPU 301.

A communication unit 309 is an interface unit between the image processing apparatus 110 and an external communication network. The communication unit 309 may be a network I/F for performing wired LAN communication, such as Ethernet, or a network I/F for performing wireless LAN communication, or a USB I/F. The wireless LAN communication refers to, for example, Wi-Fi. Further, the communication unit 309 may be configured to perform communication using Bluetooth®. The communication unit 309 is an example of a reception unit configured to receive first image data.

A data bus 310 connects components of the image processing apparatus 110 to each other, which enables the components of the image processing apparatus 110 to communicate with each other.

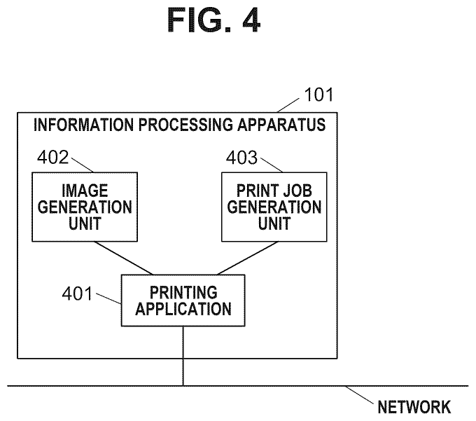

FIG. 4 is a diagram illustrating an example of a software configuration of the information processing apparatus 101.

The information processing apparatus 101 includes a printing application 401, an image generation unit 402, and a print job generation unit 403. They operate based on instructions from the CPU 201.

The printing application 401 is used to print images by the user. The printing application 401 has a function to generate and edit image data intended to be printed by the user, receive print settings and print execution instructions, and transmit the print jobs. In the present exemplary embodiment, when the user generates images using a not-illustrated image generation unit, such as an image generation application included with the OS, the CPU 201 calls the printing application 401 in response to an instruction to print the generated images.

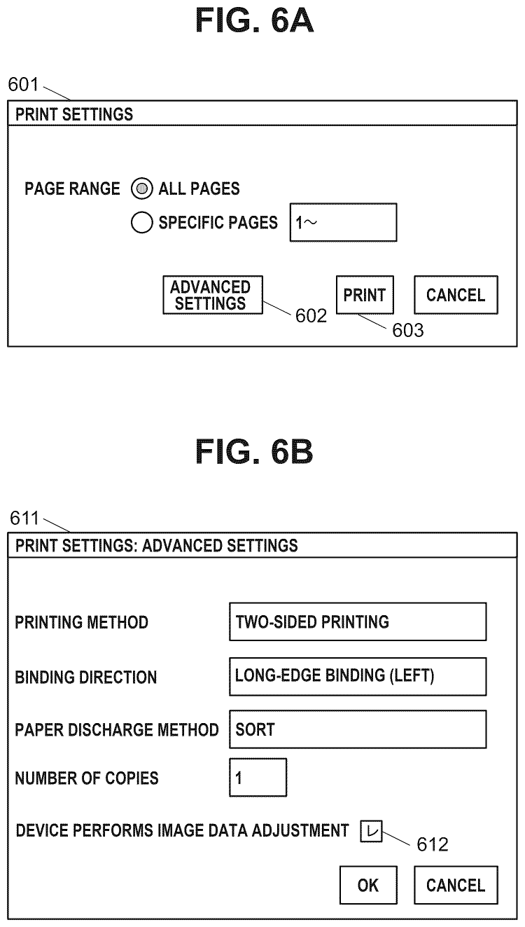

The printing application 401 displays dialog boxes illustrated in FIGS. 6A and 6B on the display unit 211 and provides the user setting items (hereinafter, “image data adjustment flags”) for determining whether the image processing apparatus 110 performs image data adjustment. The user sets the image data adjustment flags from a dialog displayed on the display unit 211, and the printing application 401 receives the flags. In the present exemplary embodiment, the setting values of the image data adjustment flags are stored in the RAM 203.

The image generation unit 402 receives an instruction from the printing application 401 and generates an image.

In the present exemplary embodiment, if the image data adjustment flag is set, the image generation unit 402 generates image data in a format (e.g., JPEG format) that facilitates image processing involving scaling. If the image data adjustment flag is not set, the image generation unit 402 generates image data in a directly printable format (e.g., binary format). The image generation unit 402 can generate image data in a format that facilitates image processing involving scaling even when the image data adjustment flag is not set.

Further, the image data adjustment flag is an example of information indicating that resizing an image based on first image data is to be executed, and setting the image data adjustment flag leads to a situation where the first image data is associated with the information indicating that resizing is to be executed on the image based on the first image data.

The print job generation unit 403 generates a print job based on the print settings and the print execution instruction from the printing application 401. In the present exemplary embodiment, print jobs are stored in the storage 204. Print jobs generated by the print job generation unit 403 can be stored in the RAM 203.

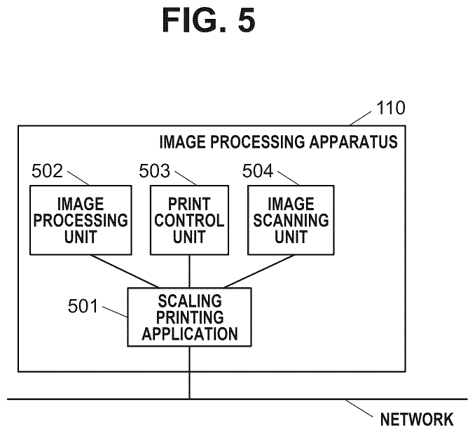

FIG. 5 is a diagram illustrating an example of a software configuration of the image processing apparatus 110.

The image processing apparatus 110 includes a scaling printing application 501, an image processing unit 502, a print control unit 503, and an image scanning unit 504, and the CPU 301 executes the processes of applications and the units.

The scaling printing application 501 monitors print jobs received (accepted) by the image processing apparatus 110 via the communication unit 309 and handles the print jobs that include the image data adjustment flags that are set. In the present exemplary embodiment, the CPU 301 of the image processing apparatus 110 stores the received jobs with the image data adjustment flags set in the storage unit 304. The CPU 301 displays a list of stored print jobs on the operation unit 305 based on a request from the user, receives a selection from the list by the user, and performs an image adjustment process on an image based on image data on the selected print job.

The image processing unit 502 performs various types of requested image processing in the image processing apparatus 110 with the image processing unit 307. In the present exemplary embodiment, the image processing unit 502 scales and moves an image based on image data and converts the image data into a binary format.

The print control unit 503 controls the print execution based on setting information of print jobs with the image processing unit 307 and the printing unit 306.

The image scanning unit 504 scans an image of an item, such as a document, with the scanning unit 308 and converts the scanned image into image data, such as in JPEG or binary format, with the image processing unit 502.

FIGS. 6A and 6B are diagrams illustrating examples of dialogs provided by the printing application 401. A print setting dialog 601 and an advanced print setting dialog 611 illustrated in FIGS. 6A and 6B are displayed on the display unit 211 by the CPU 201 of the information processing apparatus 101.

The print setting dialog 601 in FIG. 6A is a user interface (UI) through which the user issues a print execution instruction. In the present exemplary embodiment, the print setting dialog 601 includes an advanced setting button 602 and a print button 603. When the advanced setting button 602 is selected by the user, the CPU 201 displays the advanced print setting dialog 611 illustrated in FIG. 6B on the display unit 211. Further, when the print button 603 is selected by the user, the CPU 201 starts a process of instructing the print job generation unit 403 to generate a print job and transmitting the print job generated by the print job generation unit 403 to the image processing apparatus 110.

The advanced print setting dialog 611 in FIG. 6B is a UI through which the user designates advanced print settings. The advanced print settings refer to settings related to printing, such as a printing method, a binding direction, a paper discharge method, and the number of copies. In the present exemplary embodiment, the advanced print setting dialog 611 includes an image data adjustment enabling/disabling item 612 in a checkbox, in addition to the above-described advanced print settings. The image data adjustment enabling/disabling item 612 is an item for designating whether the image processing apparatus 110 is to perform image data adjustment. In the present exemplary embodiment, the user can set or clear an image data adjustment flag with the image data adjustment enabling/disabling item 612, and a checkmark “✓” is displayed when the image data adjustment flag is set to on.

The display of the on or off state of the image data adjustment enabling/disabling item 612 in the advanced print setting dialog 611 is not limited to a checkbox. For example, the on state can be displayed as a black circle, and the off state as a white circle. Alternatively, the character strings “ON” and “OFF” can be displayed simultaneously in the advanced print setting dialog 611, and an object can be displayed next to one of the character strings alone to allow the user to identify the setting.

Further, the two-character strings can be displayed in different colors. An object can be displayed next to each of the two-character strings so that the user can identify the setting from a type or shape of the object, such as a radio button. One of the character strings “ON” and “OFF” can be displayed next to the character string “device performs image data adjustment” illustrated as an example in the advanced print setting dialog 611.

In the present exemplary embodiment, a case is described where a default value is defined for every setting item in FIGS. 6A and 6B, and the default value of the image data adjustment flag is not set. The image data adjustment flag can be set as default. Furthermore, no default value may be defined for each setting item, or default values may be defined for some of the setting items alone.

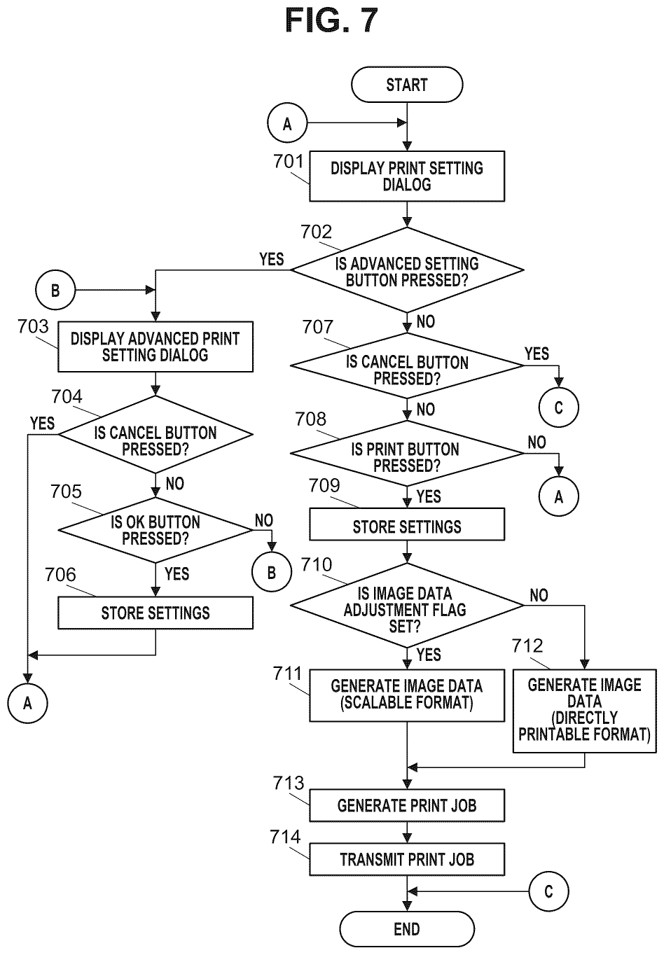

FIG. 7 is a flowchart illustrating an example of a printing process performed by the printing application 401.

This process is started when the printing application 401 for printing the generated image is called by the user from the image generation application (not illustrated) included with the OS. Further, the CPU 201 of the information processing apparatus 101 operates the printing application 401 to execute processing.

In step S701, the CPU 201 causes the display unit 211 to display the print setting dialog 601.

In step S702, the CPU 201 determines whether the advanced setting button 602 on the print setting dialog 601 is pressed. If the CPU 201 determines that the advanced setting button 602 is pressed (YES in step S702), the processing proceeds to step S703. If the CPU 201 determines that the advanced setting button 602 is not pressed (NO in step S702), the processing proceeds to step S707.

In step S703, the CPU 201 causes the display unit 211 display the advanced print setting dialog 611.

In step S704, the CPU 201 determines whether a cancel button on the advanced print setting dialog 611 is pressed. If the CPU 201 determines that the cancel button is pressed (YES in step S704), the processing proceeds to step S701. If the CPU 201 determines that the cancel button is not pressed (NO in step S704), the processing proceeds to step S705.

In step S705, the CPU 201 determines whether an OK button on the advanced print setting dialog 611 is pressed. If the CPU 201 determines that the OK button is pressed (YES in step S705), the processing proceeds to step S706. If the CPU 201 determines that the OK button is not pressed (NO in step S705), the processing proceeds to step S703.

In step S706, the CPU 201 stores, in the RAM 203, the settings set at the time of pressing the OK button on the advanced print setting dialog 611 in step S705. The storage destination of the settings can be the storage 204.

In step S707, the CPU 201 determines whether a cancel button on the print setting dialog 601 is pressed. If the CPU 201 determines that the cancel button is pressed (YES in step S707), the process ends. If the CPU 201 determines that the cancel button is not pressed (NO in step S707), the processing proceeds to step S708.

In step S708, the CPU 201 determines whether a print button on the print setting dialog 601 is pressed. If the CPU 201 determines that the print button is pressed (YES in step S708), the processing proceeds to step S709. If the CPU 201 determines that the print button is not pressed (NO in step S708), the processing proceeds to step S701. In other words, proceeding to step S701 as a result of the CPU 201 determining that the print button is not pressed indicates that the user does not perform any operations and the CPU 201 does not execute any processes.

In step S709, the CPU 201 stores, in the RAM 203, the settings set at the time of pressing the OK button on the print setting dialog 601 in step S705. The storage destination of the settings can be the storage 204.

In step S710, the CPU 201 determines whether an image data adjustment flag is set. If the CPU 201 determines that the image data adjustment flag is set (YES in step S710), the processing proceeds to step S711. If the CPU 201 determines that the image data adjustment flag is not set (NO in step S710), the processing proceeds to step S712.

In step S711, the CPU 201 causes the image generation unit 402 to generate image data in a scalable data format. In the present exemplary embodiment, a case is described where the scalable data format is JPEG format. The image data in the scalable data format is an example of first image data.

In step S712, the CPU 201 causes the image generation unit 402 to generate image data in a directly printable data format. In the present exemplary embodiment, a case is described where the directly printable data format is a binary format.

In step S713, a print job is generated based on the setting values set via the print setting dialog 601 and the advanced print setting dialog 611 stored in the RAM 203, and the image data generated in step S711 or S712. The print job is generated by the print job generation unit 403 based on an instruction from the CPU 201. When the print job generation is completed, the generated print job is transmitted to the storage 204 and stored.

In step S714, the CPU 201 transmits the print job stored in the storage 204 to the image processing apparatus 110. When step S714 is completed, the process ends.

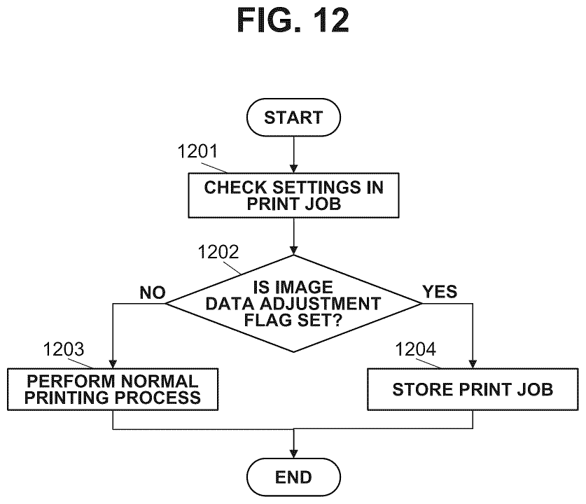

FIG. 12 is a flowchart illustrating an example of a process after the image processing apparatus 110 receives a print job. The scaling printing application 501 that monitors print job reception detects that the image processing apparatus 110 receives a print job. The process is started in response to the image processing apparatus 110 receiving a print job. The receipt of a print job by the image processing apparatus 110 is detected by the scaling printing application 501 that monitors print job reception.

Further, the CPU 301 of the image processing apparatus 110 operates the scaling printing application 501 to execute processing.

In step S1201, the CPU 301 checks the settings set for the print job received by the image processing apparatus 110.

In step S1202, the CPU 301 determines whether an image data adjustment flag is set for the received job. If the CPU 301 determines that the image data adjustment flag is set (YES in step S1202), the processing proceeds to step S1204. If the CPU 301 determines that the image data adjustment flag is not set (NO in step S1202), the processing proceeds to step S1203. In the flowchart in FIG. 12, if the image data adjustment flag is set, the processing proceeds to the direction of “Yes”, whereas if the image data adjustment flag is not set, the processing proceeds to the direction of “No”.

In step S1203, the CPU 301 performs a normal printing process on the print job received by the image processing apparatus 110. The normal printing process refers to a conventional technique that does not involve resizing, so that the detailed descriptions thereof are omitted. When the normal printing process is completed, the process ends.

In step S1204, the CPU 301 causes the storage unit 304 to store the print job received by the image processing apparatus 110 without performing the normal printing process on the print job.

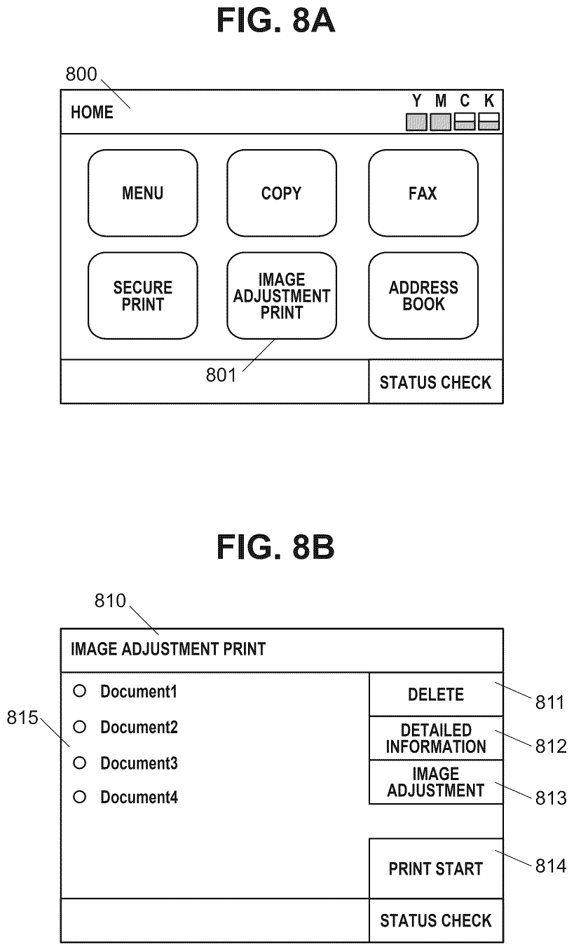

FIGS. 8A and 8B are diagrams illustrating examples of a home screen of the image processing apparatus 110 and a scaling print application screen 810. The home screen of the image processing apparatus 110 and the screen 810 of the scaling printing application 501 are screens displayed on the operation unit 305 by the CPU 301 of the image processing apparatus 110.

A home screen 800 of the image processing apparatus 110 illustrated in FIG. 8A is a basic screen where icons with various functions are arranged. Examples include icons for calling various functions carried out by the image processing apparatus 110, such as copy, and an icon for displaying a menu list. In the present exemplary embodiment, the home screen 800 includes an image adjustment print button 801 for calling the scaling printing application 501 and a status check button for displaying a not-illustrated status check screen.

When the image adjustment print button 801 is pressed by the user, the CPU 301 activates the scaling printing application 501 and causes the operation unit 305 to display the screen 810 of the scaling printing application 501.

The scaling print application screen 810 illustrated in FIG. 8B is an initial screen of the scaling printing application 501 displayed on the operation unit 305 when the image adjustment print button 801 is pressed. In the present exemplary embodiment, the scaling print application screen 810 includes a delete button 811, a detailed information button 812, an image adjustment button 813, a print start button 814, and a job list display region 815.

The four buttons, which are the delete button 811, the detailed information button 812, the image adjustment button 813, and the print start button 814, become active when a job in a job list within the job list display region 815 is selected. The job list displayed in the job list display region 815 is a list of print jobs stored in the storage unit 304 in step S1204 in FIG. 12, and the user can select a job from the displayed jobs. In the present exemplary embodiment, a case is described where the number of jobs the user can select is one.

The delete button 811 is a button for deleting a selected job from the storage unit 304. When the delete button 811 is pressed by the user, the CPU 301 deletes the job selected from the job list displayed in the job list display region 815 from the storage unit 304 and no longer displays the selected job in the job list display region 815.

The detailed information button 812 is a button for displaying various types of information about the selected job. When the detailed information button 812 is pressed by the user, the CPU 301 causes the operation unit 305 to display a not-illustrated detailed job information screen. The detailed job information screen displays various types of information about the selected job.

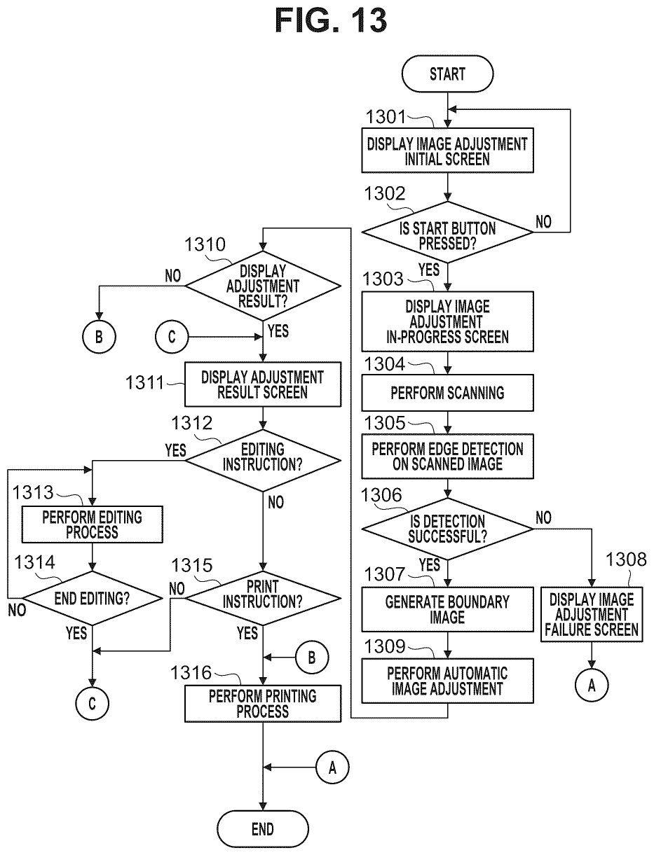

The image adjustment button 813 is a button for starting image adjustment on the selected job. Details thereof will be described below with reference to FIG. 13.

The print start button 814 is a button for starting to print the selected job. When the print start button 814 is pressed by the user, the printing unit 306 performs printing based on an instruction from the CPU 301.

In the present exemplary embodiment, the scaling print application screen 810 can be configured to allow the user to select a plurality of jobs. In this case, the image processing apparatus 110 simultaneously or continuously performs the image adjustment process described in the present exemplary embodiment.

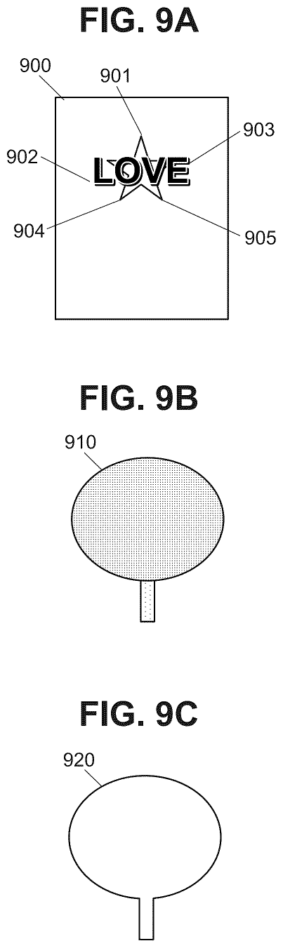

FIGS. 9A to 9C are diagrams illustrating examples of image data 900, an item 910, and a boundary image 920 of the item 910. FIG. 9A illustrates an image intended to be printed by the user. The image includes the character string “LOVE” on top of a star-shaped sheet.

The part of the image data 900 where the image exists (hereinafter, the part will be referred to as “adjustment image”) has endpoints, such as upper, lower, left, and right endpoints, which refer to the points at the uppermost, lowermost, leftmost, and rightmost ends. In a case where there is a plurality of points at the farthest ends, all of the points are considered to be ends. In the present exemplary embodiment, the adjustment image has an upper endpoint 901, a left endpoint 902, a right endpoint 903, and lower endpoints 904 and 905. The lower endpoints 904 and 905 are an example of the case where there is a plurality of points at the farthest ends, and all of them are treated as ends.

FIG. 9B illustrates the item 910 in the shape of a fan as an example of an item with which the user intends to make original goods. FIG. 9C illustrates an example of the boundary image 920 acquired from the item 910.

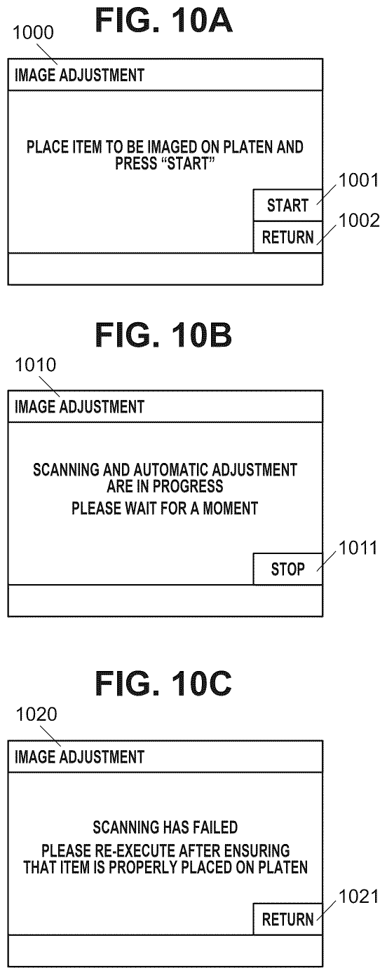

FIGS. 10A to 10C illustrate examples of screens displayed on the operation unit 305 during the image adjustment process. FIGS. 10A, 10B, and 10C respectively illustrate an image adjustment initial screen 1000, an image adjustment in-progress screen 1010, and an image adjustment failure screen 1020. Further, the screens 1000, 1010, and 1020 are displayed on the operation unit 305 by the CPU 301.

The image adjustment initial screen 1000 is displayed when the image adjustment button 813 on the scaling print application screen 810 is pressed. The image adjustment initial screen 1000 includes a start button 1001 and a return button 1002. Further, in the present exemplary embodiment, the message “place item to be imaged on platen and press ‘start’” is displayed to prompt the user to scan the item. Any wording of the message is used and displaying the message is not mandatory.

The image adjustment in-progress screen 1010 is a screen displayed while the image processing apparatus 110 is executing the image adjustment process. The image adjustment in-progress screen 1010 includes a stop button 1011. In the present exemplary embodiment, the messages “scanning and automatic adjustment are in progress” and “please wait for a moment” are displayed to notify the user that the image adjustment process is in progress. Any wording of the message is used and displaying the message is not mandatory.

The image adjustment failure screen 1020 is a screen displayed when a scanning has failed. The image adjustment failure screen 1020 includes a return button 1021. In the present exemplary embodiment, the messages “scanning has failed” and “please re-execute after ensuring that item is properly placed on platen” are displayed to notify the user that the scanning process has failed. Any wording of the message is used and displaying the message is not mandatory.

The operation of the image processing apparatus 110 when a button on the image adjustment initial screen 1000, the image adjustment in-progress screen 1010, or the image adjustment failure screen 1020 is pressed will be described below with reference to a flowchart illustrated in FIG. 13. When the return button 1002 on the image adjustment initial screen 1000 or the stop button 1011 on the image adjustment in-progress screen 1010 is pressed, the CPU 301 ends the image adjustment process and causes the operation unit 305 to display the scaling print application screen 810.

FIG. 13 is a flowchart illustrating an example of the image adjustment process performed by the image processing apparatus 110. When the image adjustment button 813 on the scaling print application screen 810 is pressed by the user, the image adjustment process is started and performed by the CPU 301. Further, the CPU 301 of the image processing apparatus 110 operates the scaling printing application 501 to execute processing.

In step S1301, the CPU 301 causes the operation unit 305 to display the image adjustment initial screen 1000.

In step S1302, the CPU 301 determines whether the start button 1001 is pressed. If the CPU 301 determines that the start button 1001 is pressed (YES in step S1302), the processing proceeds to step S1303. If the CPU 301 determines that the start button 1001 is not pressed (NO in step S1302), the processing proceeds to step S1301.

In step S1303, the CPU 301 causes the operation unit 305 display the image adjustment in-progress screen 1010.

In step S1304, the CPU 301 causes the scanning unit 308 to scan the item 910. During the scanning, scanned image data on the item 910 is obtained in a situation where the item 910 is set on the scanning unit 308 by the user, or a blank scanned image is obtained in a situation where the item 910 is not set. In the present exemplary embodiment, a case is described where the item 910 illustrated in FIG. 9B is set on the scanning unit 308 by the user.

In step S1305, the CPU 301 performs edge detection on the scanned image of the item 910 scanned in step S1304 and acquires image data corresponding to the boundary of the item 910. Any edge detection method capable of detecting edges can be used, such as a method using luminance discontinuities. The image data corresponding to the boundary of the item 910 is an example of second image data.

In step S1306, the CPU 301 determines whether the edge detection on the item 910 in step S1305 is successful. If the CPU 301 determines that the edge detection is successful (YES in step S1306), the processing proceeds to step S1307. If the CPU 301 determines that the edge detection is unsuccessful (NO in step S1306), the processing proceeds to step S1308. The phrase “the edge detection is unsuccessful” indicates that the edge detection is unsuccessful for a specific reason, and the examples include cases where the item 910 is not placed on the scanning unit 308 by the user and a blank scanned image is obtained, and where the item 910 is colorless and transparent and the scanning unit 308 fails to scan the item 910.

In step S1307, the CPU 301 determines the outermost line extraction, among the edges detected in step S1305, as the boundary of the item 910 and acquires the outermost line extraction as the boundary image 920. In the present exemplary embodiment, a solid line of the boundary image 920 in FIG. 9C represents the line obtained by extracting the outermost line among the edges detected from the scanned image of the item 910, and is the boundary of the item 910. This is not a limiting method and any method capable of acquiring the boundary of the item 910 image 920 can be used. For example, the second outermost line or a line selected by the user can be acquired as a boundary. In this manner, a boundary on the boundary image 920 is acquired.

In step S1308, the CPU 301 causes the operation unit 305 to display the image adjustment failure screen 1020. When the return button 1021 is pressed by the user, the process ends. Further, the CPU 301 causes the operation unit 305 to display the scaling print application screen 810.

In step S1309, the CPU 301 performs automatic image adjustment. Specifically, the adjustment image is moved, enlarged, or reduced to fit within the boundary of the item 910. The enlargement or reduction of the adjustment image varies depending on the size relationship between the adjustment image and the boundary of the item 910. If the adjustment image is larger than the boundary, the CPU 301 reduces the adjustment image, whereas if the adjustment image is smaller than the boundary, the CPU 301 enlarges the adjustment image. The adjustment process is performed automatically without a size specification from the user. When the adjustment process is completed, the processing proceeds to step S1310.

The CPU 301 can be configured not to enlarge the adjustment image even if the adjustment image is smaller than the boundary.

The processing may proceed to step S1316, not step S1310, after the adjustment process, to perform printing immediately. In the present exemplary embodiment, the CPU 301 performs automatic adjustment using the boundary on the boundary image 920 and all of the points (endpoints) at the uppermost, lowermost, leftmost, and rightmost ends of the adjustment image 920 to fit the adjustment image within the boundary. Specifically, the adjustment image is resized to fit within the boundary.

An example of automatic adjustment will be described. First, the CPU 301 changes the position of the adjustment image relative to the boundary image 920 and determines whether a location exists where all the endpoints of the adjustment image fit within the boundary. If a location exists where all the endpoints of the adjustment image fit within the boundary, the CPU 301 enlarges the adjustment image and determines again whether a location exists where all the endpoints of the adjustment image fit within the boundary. The CPU 301 repeats the foregoing process while gradually enlarging the size of the adjustment image until no location exists where all endpoints of the adjustment image fit within the boundary. If no location exists where all the endpoints of the adjustment image fit within the boundary, the CPU 301 restores the adjustment image to the previous size, moves the adjustment image to the location where all the endpoints of the adjustment image fit within the boundary, and ends the automatic adjustment. It is not mandatory to enlarge the adjustment image in this case. If the presence of a location where all the endpoints of the adjustment image fit within the boundary is determined during the first check, the CPU 301 can terminate the automatic adjustment.

If no locations exist where all the endpoints of the adjustment image fit within the boundary, the CPU 301 reduces the size of the adjustment image and determines again whether a location exists where all the endpoints of the adjustment image fit within the boundary. The CPU 301 repeats the foregoing process while gradually reducing the size of the adjustment image until a location exists where all the endpoints of the adjustment image fit within the boundary. When a location exists where all the endpoints of the adjustment image fit within the boundary, the automatic adjustment ends.

The foregoing method is an example of a method for adjusting the position and the size of the adjustment image by the CPU 301, and another method can be used. An example of another method is a method in which the position of the boundary image 920 relative to the adjustment image is gradually changed to determine whether a location exists where all the endpoints of the adjustment image fit within the boundary. Specifically, the CPU 301 can perform automatic adjustment by changing the position of either the adjustment image or the boundary image 920.

Further, the CPU 301 can be configured to change one of the position and size of the adjustment image to fit the adjustment image within the boundary and terminate the adjustment.

Step S1309 is an example of a process of resizing an image based on the first image data to fit within the boundary of the item 910 on an image based on the second image data.

In step S1310, the CPU 301 determines whether to display the image adjustment result. If the CPU 301 determines to display the image adjustment result (YES in step S1310), the processing proceeds to step S1311. If the CPU 301 determines not to display the image adjustment result (NO in step S1310), the processing proceeds to step S1316. Further, step S1310 is not a mandatory step. If the CPU 301 does not perform step S1310, the CPU 301 performs the scanning process in step S1304 to the printing process in step S1316 without receiving an instruction from the user. Specifically, when the automatic image adjustment (step S1309) is completed, the processing proceeds to the printing process (step S1316), and the CPU 301 performs the process.

The CPU 301 determines whether to display the image adjustment result, for example, as described in the following.

For example, a not-illustrated display setting item, such as “display adjustment result after image adjustment” can be provided on the scaling print application screen 810. If the display setting item is set to “display” by the user, the CPU 301 determines to display the image adjustment result, whereas if the display setting item is set to “not display” by the user, the CPU 301 determines not to display the image adjustment result. Alternatively, the CPU 301 checks whether the image processing apparatus 110 supports a function of displaying the image adjustment result, and if the function is supported, the CPU 301 determines to display the image adjustment result, whereas if the function is not supported, the CPU 301 determines not to display the image adjustment result. This is uniformly defined as the specification for each product in the present exemplary embodiment.

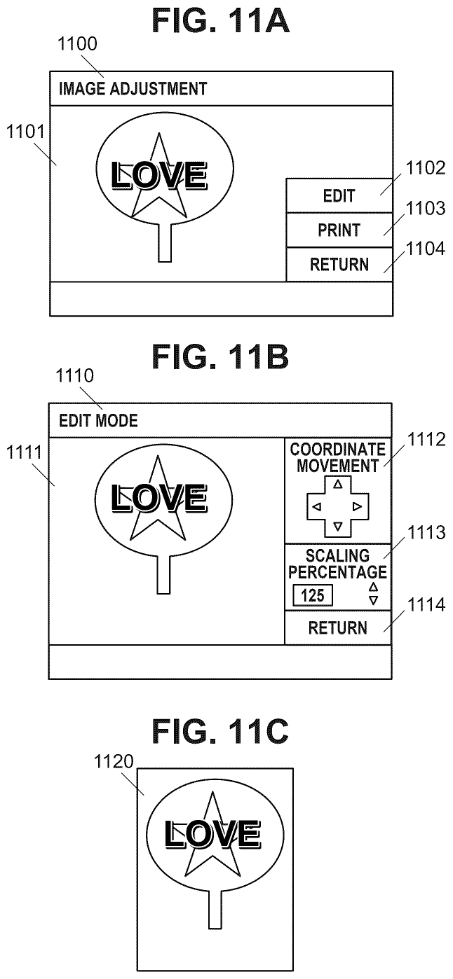

In step S1311, the CPU 301 causes the operation unit 305 to display a screen representing the automatic adjustment result from step S1309. In the present exemplary embodiment, an image adjustment result screen 1100 illustrated in FIG. 11A described below is displayed.

In step S1312, the CPU 301 determines whether the user issues an editing instruction on the image adjustment result screen 1100. If the CPU 301 determines that the user issues an editing instruction (YES in step S1312), the processing proceeds to step S1313. If the CPU 301 determines that the user does not issue an editing instruction (NO in step S1312), the processing proceeds to step S1315. In the present exemplary embodiment, the CPU 301 determines whether an editing instruction is issued based on whether an edit button 1102 illustrated in FIG. 11A described below is pressed. Specifically, if the edit button 1102 is pressed, the CPU 301 determines that an editing instruction is issued, whereas if the edit button 1102 is not pressed, the CPU 301 determines that an editing instruction is not issued.

In step S1313, the CPU 301 causes the operation unit 305 to display an edit mode screen 1110. Further, the CPU 301 receives manual editing performed by the user, such as enlarging, reducing, or moving the image, via the edit mode screen 1110.

In step S1314, the CPU 301 determines whether the user issues an instruction to end the editing. If the CPU 301 determines that the user issues an instruction to end the editing (YES in step S1314), the edits are stored, and the processing proceeds to step S1311. If the user does not issue an instruction to end the editing (NO in step S1314), the processing proceeds to step S1313.

In the present exemplary embodiment, the CPU 301 determines whether an instruction to end the editing is issued based on whether a return button 1114 illustrated in FIG. 11B described below is pressed. Specifically, in a case where the return button 1114 is pressed, the CPU 301 determines that an instruction to end the editing is issued, whereas if the return button 1114 is not pressed, the CPU 301 determines that an instruction to end the editing is not issued.

In step S1315, the CPU 301 determines whether the user issues a print execution instruction. If the CPU 301 determines that the user issues a print execution instruction (YES in step S1315), the processing proceeds to step S1316. If the CPU 301 determines that the user does not issue a print execution instruction (NO in step S1315), the processing proceeds to step S1311. In the present exemplary embodiment, the CPU 301 determines whether a print execution instruction is issued based on whether a print button 1103 illustrated in FIG. 11A described below is pressed. Specifically, if the print button 1103 is pressed, the CPU 301 determines that a print execution instruction is issued, whereas if the print button 1103 is not pressed, the CPU 301 determines that a print execution instruction is not issued.

In step S1316, the CPU 301 controls the printing unit 306 to print the image subjected to the image adjustment process (the image displayed on an image display region 1101) on a printing medium. Further, at this time, the print control unit 503 controlled by the CPU 301 changes parameters of the print job or converts the image data format as appropriate. In the present exemplary embodiment, the CPU 301 performs printing when the print button 1103 is pressed.

FIGS. 11A to 11C are diagrams illustrating examples of screens displaying results of automatic image adjustment performed by the scaling printing application 501 controlled by the CPU 301. FIGS. 11A, 11B, and 11C respectively illustrate the image adjustment result screen 1100, the edit mode screen 1110, and a printed material 1120, and the image adjustment result screen 1100 and the edit mode screen 1110 are displayed on the operation unit 305 by the CPU 301.

The image adjustment result screen 1100 is displayed when the automatic image adjustment is completed (step S1311). The image adjustment result screen 1100 includes the image display region 1101, the edit button 1102, the print button 1103, and a return button 1104.

The image display region 1101 is a region where the image adjusted in step S1309 and the boundary image 920 are superimposed and displayed, which functions as a print preview.

The edit button 1102 is a button for CPU 301 to receive an editing instruction via from the user. When the edit button 1102 is pressed, the CPU 301 causes the operation unit 305 to display the edit mode screen 1110. The edit button 1102 can be configured to be hidden when the image processing apparatus 110 does not support the function of image adjustment as instructed by the user.

The print button 1103 is a button for the CPU 301 to receive a print execution instruction from the user. When the print button 1103 is pressed, the CPU 301 controls the print control unit 503 to print an image based on the image displayed in the image display region 1101 with the printing unit 306 and output the printed material 1120. In performing printing, if parameters of the print jobs are changed based on the image adjustment, the print control unit 503 controlled by the CPU 301 performs printing after updating the parameters to values based on the image adjustment.

In the present exemplary embodiment, the image data is in JPEG format for image processing, and when the print button 1103 is pressed, the CPU 301 controls the image processing unit 502 to convert the image data from JPEG format into a directly printable format and performs printing.

In response to the return button 1104 being pressed, the CPU 301 causes the operation unit 305 to display the scaling print application screen 810.

The edit mode screen 1110 is a screen where the user manually operates a position of the image data and enlarges or reduces the image data. The edit mode screen 1110 includes an image display region 1111, a position movement key 1112, a scaling percentage operation button 1113, and the return button 1114.

The image display region 1111 is a region where the adjusted image and the boundary image 920 are superimposed and displayed, which functions as a print preview. The user can edit the image using the position movement key 1112 and the scaling percentage operation button 1113 (step S1313). The print preview displayed in the image display region 1111 reflects the edits made to the image by the user.

The position movement key 1112 is a software key for the CPU 301 to receive a user operation via to move the position of the adjustment image. The user operates the position movement key 1112 to move the position of the adjustment image. In the present exemplary embodiment, a position of the boundary image 920 is fixed, and the user moves the position of the adjustment image relative to the boundary image 920.

A configuration that allows the user to move the position of the boundary image 920 alone can be employed, or a configuration that allows the user to move both the adjustment image and the boundary image 920 can be employed. In the present exemplary embodiment, the position movement key 1112 as a cross-shaped software key is described, this is not a limitation. An input device, such as a hardware key or a mouse, can be connected to the image processing apparatus 110, and the CPU 301 can move a position of the adjustment image based on a user operation input from the input device. Further, the position movement input is not limited to an input from a directional pad and can be input from, for example, a joystick.

The scaling percentage operation button 1113 is an object for the CPU 301 to receive a user operation via to change a scaling percentage (size) of the adjustment image. The user operates the scaling percentage operation button 1113 to adjust the scaling percentage of the adjustment image. In the present exemplary embodiment, a selection of an upward-pointing triangle object of the scaling percentage operation button 1113 by the user increases the scaling percentage, and enlarges a size of the adjustment image displayed in the image display region 1111. On the other hand, a selection of a downward-pointing triangle object of the scaling percentage operation button 1113 by the user decreases the scaling percentage, and reduces a size of the adjustment image displayed in the image display region 1111. Further, the displayed value of the scaling percentage changes as the user adjusts the scaling percentage.

While the user changes a scaling percentage of the adjustment image using the scaling percentage operation button 1113 in the present exemplary embodiment, this is not a limiting method of changing the scaling percentage.

For example, a configuration can be employed where the user selects the region displaying a numerical value of the scaling percentage to display candidate numerical values. The user then chooses any value from the candidate numeral values, and the selected value will be applied as the scaling percentage. Further, a configuration can be employed where a scaling percentage is changed based on a rotation direction of a wheel, such as a mouse wheel. In a case where the image processing apparatus 110 includes a touch panel or a trackpad, the scaling percentage can be changed based on a flick operation or a pinch-in/pinch-out operation.

The return button 1114 is a button for terminating the edit mode screen 1110. When the return button 1114 is pressed by the user after finishing editing, the CPU 301 causes the operation unit 305 to display the scaling print application screen 810. At this time, the edits made to the adjustment image by the user are stored, and the adjustment image reflecting the edits is displayed in the image display region 1101 on the switched image adjustment result screen 1100.

When the return button 1114 is pressed by the user, a message, such as “Do you want to reflect the edits?”, together with a not-illustrated dialog may be displayed to prompt the user to select whether to store the edits. In this case, when the user selects an option of “Yes”, the CPU 301 can store the edits made to the adjustment image by the user and causes the image display region 1101 to display the adjustment image reflecting the edits. On the other hand, when the user selects an option of “No”, the CPU 301 can cause the image display region 1101 to display the adjustment image before the edits are reflected without storing the edits made to the adjustment image by the user.

A not-illustrated finish button can be provided on the edit mode screen 1110, and the following configuration can be employed. When the finish button is pressed by the user, the edits are stored, and the adjustment image reflecting the edits is displayed in the image display region 1101 on the image adjustment result screen 1100 displayed on the operation unit 305 by the CPU 301. On the other hand, when the return button 1114 is pressed by the user, the changes are discarded, and the adjustment image before the edits are reflected is displayed in the image display region 1101 on the image adjustment result screen 1100 displayed on the operation unit 305 by the CPU 301.

FIG. 11C illustrates the printed material 1120 on which an image of the image adjustment result is printed, as an example of an image output as a result that the print button 1103 is pressed by the user and printing is performed by the printing unit 306. While the boundary image 920 is also printed so that the user can use the boundary image 920 as a cutting line in the present exemplary embodiment, a configuration that does not print the boundary image 920 can be employed. In this case, for example, the image adjustment result screen 1100 may include an item that allows the user to set whether to print the boundary image 920. The boundary line can be printed as, for example, a dashed line or in a pale color.

Further, if the setting item is not included, a message, such as “Do you want to print the boundary?”, together with a not-illustrated dialog may be displayed to prompt the user to select whether to print the boundary image 920 in a case where the print button 1103 is pressed by the user. In this case, when the user selects an option of “Yes”, the CPU 301 can cause the printing unit 306 to print an image including the boundary image 920. On the other hand, when the user selects an option of “No”, the CPU 301 can cause the printing unit 306 to print an image without the boundary image 920.

The present exemplary embodiment makes it possible to reduce tasks involved in print settings when printing an image at a size intended by the user.

In the present exemplary embodiment, while an example is described of printing the adjustment image following the automatic adjustment of the adjustment image (step S1309), this is not a limitation, and the adjustment image after the automatic adjustment or after editing by the user can be stored. In this case, for example, the image adjustment result screen 1100 can be configured to include a not-illustrated store button. When the store button is pressed by the user, the CPU 301 stores an image file of the print preview displayed in the image display region 1101 in a storage medium, such as the storage unit 304.

In the present exemplary embodiment, a configuration is described in which the image processing apparatus 110 scans the item and performs image adjustment after the user selects the adjustment image. However, the user may select the adjustment image and then image adjustment can be performed after the image processing apparatus 110 scans the item.

While a scanned image of the item 910 is acquired by scanning the item 910 after the user selects a print job in the present exemplary embodiment, the present exemplary embodiment can also be implemented by preparing a scanned image of the item 910 in advance. In this case, step S1304 can be a process in which the user selects an image of the item 910 stored in the storage unit 304, instead of scanning an image of the item 910 with the scanning unit 308. Further, the process can be configured so that the user selects an image of the item 910 from, for example, a USB device, an external storage device, or a cloud server, instead of the storage unit 304.

While the user makes setting of the image data adjustment flags on the information processing apparatus 101 in the present exemplary embodiment, this is not a limitation. For example, the operation unit 305 of the image processing apparatus 110 can display a list of print jobs received by the image processing apparatus 110, and the user can make setting of the image data adjustment flags from the operation unit 305.

### Modified Examples

The first exemplary embodiment may be implemented by a configuration including a server in addition to the information processing apparatus 101 and the image processing apparatus 110. The server herein refers to an external server different from the information processing apparatus 101 and the image processing apparatus 110, such as a cloud server. As described above, if the configuration is employed where the adjustment image after automatic adjustment or after editing by the user is stored, the CPU 301 stores the image file of the print preview displayed in the image display region 1101 on, for example, a cloud server in response to the store button being pressed by the user.

This enables the user to print the stored image file at a desired time, which improves convenience. Further, storing the image file on the cloud server facilitates data exchange, which produces the effect that, for example, a user with a printing apparatus that has the automatic adjustment function alone can easily make the same goods as other users by receiving the image file.

### Other Embodiments

In the first exemplary embodiment, during scanning the item 910 in step $1304, it is on the assumption that the item 910 fits within the scanning unit 308. However, in reality, the scanning unit 308 may scan an item larger than the range that can be covered in a single scan.

Even when the item does not fit within the scanning unit 308, embodiments of the present disclosure can still be implemented by scanning the item in a plurality of passes and combining the plurality of scanned images together to obtain a scanned image of the item in in step S1304.

In the present exemplary embodiment, a case is described where an item is scanned in a plurality of passes. In the present exemplary embodiment, while a method of performing scanning in two passes and combining the two images together is particularly described, embodiments of the present disclosure can also be implemented by a method of scanning in three or more passes.

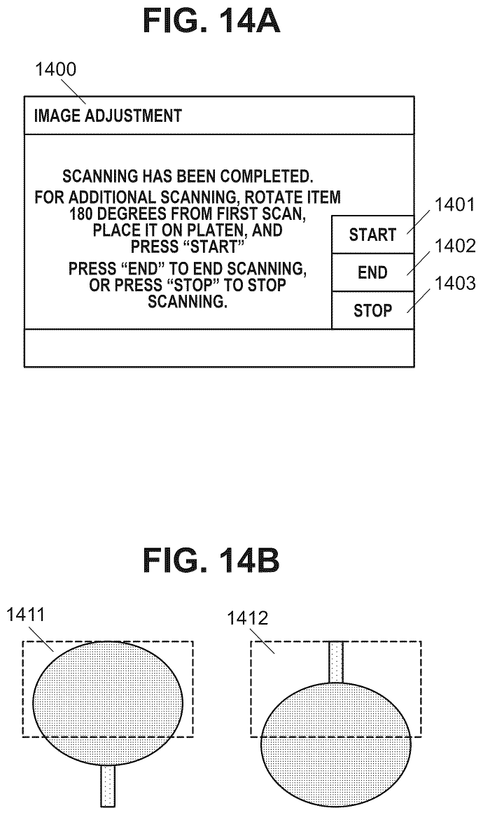

FIGS. 14A and 14B are diagrams illustrating an example of an additional scanning confirmation screen 1400 displayed on the operation unit 305 for additional item scanning and examples of an item scanning range.

The additional scanning confirmation screen 1400 in FIG. 14A is a screen displayed on the operation unit 305 to confirm with the user regarding additional scanning of the item to be used in image adjustment by the scaling printing application 501 controlled by the CPU 301. The additional scanning confirmation screen 1400 includes an additional scanning start button 1401, an additional scanning end button 1402, and a stop button 1403.

The additional scanning confirmation screen 1400 is displayed on the operation unit 305 by the CPU 301 when the item scanning is completed after the image adjustment in-progress screen 1010 is displayed on the operation unit 305 by the CPU 301 in step S1304.

The additional scanning start button 1401 is a button for the CPU 301 to receive a user instruction via to execute additional scanning of the item. When the additional scanning start button 1401 is pressed, the scanning unit 308 controlled by the CPU 301 starts scanning the item. At this time, the CPU 301 causes the operation unit 305 to display the image adjustment in-progress screen 1010 again and the scanning of the item is executed. When the scanning is finished, the image processing unit 502 controlled by the CPU 301 combines the scanned images of the item together. When the combining of the scanned images is completed, the processing proceeds to step S1305.

In the present exemplary embodiment, the image processing apparatus 110 prompts the user to set the item in a position rotated by 180 degrees on the additional scanning confirmation screen 1400 to scan mainly a part that did not fit within the scanning range of the scanning unit 308 in the first scan. It is sufficient to combine the scanned images obtained through the scanning process performed in a plurality of passes, and a rotation angle and an orientation of the item and the number of scans can be set as desired.

FIG. 14B illustrates an example of scanning ranges of the item in first and second scans. A first scanning range 1411 and a second scanning range 1412 respectively illustrate first and second scanning ranges when the item 910 does not fit within the scanning unit 308.

Provided that a range indicated by a dashed line represents a range that fits within the scanning unit 308, it is not possible to read the entire item 910 in a single scan. Thus, after the scanning unit 308 scans the first scanning range 1411 in the first scan, the user rotates the item 910 by 180 degrees, so that the part that did not fit within the first scanning range 1411 is fitted within the range of the scanning unit 308. The scanning unit 308 then scans the second scanning range 1412 in the second scan. When scanning of the entire item 910 is completed, the image processing unit 502 combines the scanned images of the item 910. The combining (merging) can be performed using a typical image merging method in which the scanned image from the second scan is rotated by 180 degrees and then merged with the scanned image from the first scan.

The additional scanning end button 1402 is a button for the CPU 301 to receive a user instruction via to end the additional scanning of the item. When the additional scanning end button 1402 is pressed, the CPU 301 ends the scanning in step S1304.

The stop button 1403 is a button for the CPU 301 to receive a user instruction via to stop the additional scanning of the item. When the stop button 1403 is pressed, the CPU 301 ends the image adjustment process and causes the operation unit 305 to display the scaling print application screen 810.

With the foregoing configuration, even when the item 910 does not fit within the scanning unit 308, embodiments of the present disclosure can still be implemented by scanning the item 910 in a plurality of passes.

Embodiments of the present disclosure can also be implemented by a process in which a program configured to carry out one or more functions of the above-described embodiments is supplied to a system or an apparatus via a network or a storage medium and one or more processors of a computer of the system or the apparatus read and execute the program. Further, embodiments of the present disclosure can also be implemented by a circuit (such as an Application-Specific Integrated Circuit (ASIC)) configured to carry out the one or more functions.

According to the exemplary embodiments, tasks involved in print settings when printing an image at a size intended by the user can be reduced.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-063309, filed Apr. 10, 2024, which is hereby incorporated by reference herein in its entirety.

What is claimed is:

1. An image forming apparatus comprising:
a reception unit configured to receive first image data;
an acquisition unit configured to acquire second image data corresponding to a boundary of an item by scanning the item;
a changing unit configured to resize an image based on the first image data to fit within the boundary of the item on an image based on the second image data without receiving a size specification for the image based on the first image data from a user; and
a printing unit configured to print the image resized by the changing unit on a printing medium.

2. The image forming apparatus according to claim 1, wherein the changing unit does not resize the image based on the second image data.

3. The image forming apparatus according to claim 1, wherein in a situation where the image based on the first image data and the image based on the second image data are superimposed, the changing unit fits the image based on the first image data within the boundary of the item on the image based on the second image data by changing a position of at least one of the image based on the first image data and the image based on the second image data.

4. The image forming apparatus according to claim 1, wherein the reception unit receives the first image data based on a selection made by the user.

5. The image forming apparatus according to claim 4, further comprising a display unit configured to display an option to prompt the user to make the selection.

6. The image forming apparatus according to claim 1, further comprising a display unit configured to display the image based on the first image data resized by the changing unit.

7. The image forming apparatus according to claim 6, wherein the printing unit prints, on a printing medium, the image resized by the changing unit without displaying the image resized by the changing unit on the display unit.

8. The image forming apparatus according to claim 1, wherein the printing unit prints, on the same printing medium, the image based on the second image data and the image based on the first image data resized by the changing unit to fit within the boundary of the item on the image based on the second image data.

9. The image forming apparatus according to claim 1, wherein in a situation where the first image data is associated with information indicating that the resizing is to be executed on the image based on the first image data, the changing unit performs the resizing.

10. The image forming apparatus according to claim 1, further comprising an instruction reception unit configured to receive an instruction whether to perform the resizing from the user via an operation unit,
wherein in a situation where an instruction to perform the resizing from the user is received by the instruction reception unit, the changing unit performs the resizing.

11. The image forming apparatus according to claim 1, further comprising a storage unit configured to store image data corresponding to the image resized by the changing unit.

12. The image forming apparatus according to claim 1, wherein the image based on the first image data is resized to fit within the boundary of the item on the image based on the second image data without receiving an execution instruction from the user after the item is scanned.

13. The image forming apparatus according to claim 12, wherein the printing unit prints the image resized by the changing unit on the printing medium without receiving an execution instruction from the user after the item is scanned.

14. An image forming method comprising:
receiving first image data;
acquiring second image data corresponding to a boundary of an item by scanning the item;
resizing an image based on the first image data to fit within the boundary of the item on an image based on the second image data without receiving a size specification for the image based on the first image data from a user; and
printing the resized image on a printing medium.

15. A non-transitory computer-readable storage medium storing a program including instructions, which when executed by one or more processors of an image forming apparatus, cause the image forming apparatus to perform operations comprising:
receiving first image data;
acquiring second image data corresponding to a boundary of an item by scanning the item;
resizing an image based on the first image data to fit within the boundary of the item on an image based on the second image data without receiving a size specification for the image based on the first image data from a user; and
printing the resized image on a printing medium.
